(19) United States
(12) Patent Application Publication
(10) Pub. No.: US 2016/0169503 A1
(43) Pub. Date: Jun. 16, 2016

(54) LED LAMP FOR CEILING FAN AND CEILING FAN HAVING THE SAME

(71) Applicants: Shih-Yun CHEN, Hsinchu City (TW); Chi-Han JAO, Taichung City (TW); Chia-Sheng CHENG, Hsinchu City (TW)

(72) Inventors: Shih-Yun CHEN, Hsinchu City (TW); Chi-Han JAO, Taichung City (TW); Chia-Sheng CHENG, Hsinchu City (TW)

(21) Appl. No.: 14/569,780

(22) Filed: Dec. 14, 2014

(51) Int. Cl. F21V 33/00; F21K 99/00; F04D 29/38; F04D 19/00; F04D 25/08; F04D 29/32; F21V 1/00; F21V 23/00

(52) U.S. Cl. CPC F21V 33/0096; F21V 1/00; F21K 9/30; F21V 23/002; F04D 19/002; F04D 25/088; F04D 29/325; F04D 29/38; F21Y 2105/001

(57) ABSTRACT

A LED lamp for a ceiling fan includes a plate body, a light module and a translucent lampshade. A plate body has a central protruding part and a surrounding part surrounding the central protruding part. The central protruding part protrudes from the surrounding part. The light module includes a carrier board fixed to the central protruding part and a plurality of LED components as well as a plurality of electronic components which are electrically disposed on the carrier board. The translucent lampshade corresponds to and covers the central protruding part and is fixed to the plate body. The light module is between the translucent lampshade and the plate body. When assembling the LED lamp, the translucent lampshade corresponds to and covers the central protruding part and is fixed to the plate body. Thereby, it is easy and convenient regarding the assembly processes and this reduces the cost of assembly.

### TECHNICAL FIELD

The disclosure relates to a lamp, more particularly to a LED lamp for a ceiling fan and a ceiling fan having the LED lamp.

### BACKGROUND

A ceiling fan is hung on the ceiling and generates airflow by its blades rotating. Now the multifunctional ceiling fan with a lamp for lighting and generating airflow can be found on the market

A current lamp for being installed on the ceiling fan comprises a base to be fixed to the ceiling fan, a light bulb disposed on the base and a translucent lampshade covering and fixed to the base. The light bulb is between the base and the translucent lampshade so that light from the light bulb may pass through the translucent lampshade for lighting.

The fixing processes of the current translucent lampshade and base, however, are complicated. This makes the assembly troublesome and inconvenient, which leads to a high cost of assembly.

Thus, the objective of the disclosure is to provide an improved design capable of solving the problems mentioned above.

### SUMMARY

The disclosure is intended to provide a LED lamp for a ceiling fan and a ceiling fan having the LED lamp, in which a translucent lampshade corresponds to a central protruding part and is fixed to a plate body. Thereby, it is easy and convenient when assembling the device and this reduces the cost of assembly.

To reach this goal, the disclosure provides a LED lamp for a ceiling fan comprising a plate body, a light module and a translucent lampshade. A plate body has a central protruding part and a surrounding part surrounding the central protruding part. The central protruding part protrudes from the surrounding part. The light module comprises a carrier board fixed to the central protruding part and a plurality of LED components as well as a plurality of electronic components which are electrically disposed on the carrier board. The translucent lampshade corresponds to and covers the central protruding part and it is fixed to the plate body. The light module is between the translucent lampshade and the plate body.

Moreover, a ceiling fan having a LED lamp is provided and it comprises a ceiling fan body, a plurality of blades, an outer translucent mask and the LED lamp. The ceiling fan body has a fixing base. The blades are connected to the ceiling fan body. The outer translucent mask covers and is fixed to the fixing base, wherein the outer translucent mask and the fixing base forms an accommodating space between them. The LED lamp is accommodated in the accommodating space and comprises a plate body, a light module and a translucent lampshade. A plate body is fixed to the fixing base and has a central protruding part and a surrounding part surrounding the central protruding part. The central protruding part protrudes from the surrounding part. The light module comprises a carrier board fixed to the central protruding part and a plurality of LED components as well as a plurality of electronic components which are electrically disposed on the carrier board. The translucent lampshade corresponds to and covers the central protruding part and it is fixed to the plate body. The light module is between the translucent lampshade and the plate body.

When assembling the LED lamp, the translucent lampshade corresponds to and covers the central protruding part and thus is fixed to the plate body. Compared to Prior Art, this is easier and more convenient regarding the assembly processes and this design reduces the cost of assembly.

### BRIEF DESCRIPTION OF THE DRAWINGS

The disclosure will become more fully understood from the detailed description and the drawings given herein below for illustration only, and thus does not limit the disclosure, wherein:

FIG. 1 is an exploded view of a LED lamp of the disclosure;

FIG. 2 is a perspective view in relation to FIG. 1;

FIG. 3 is a sectional view of FIG. 2;

FIG. 4 is an exploded view of a ceiling fan of the disclosure;

FIG. 5 is a perspective view in relation to FIG. 4; and

FIG. 6 is a sectional view of a LED lamp according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

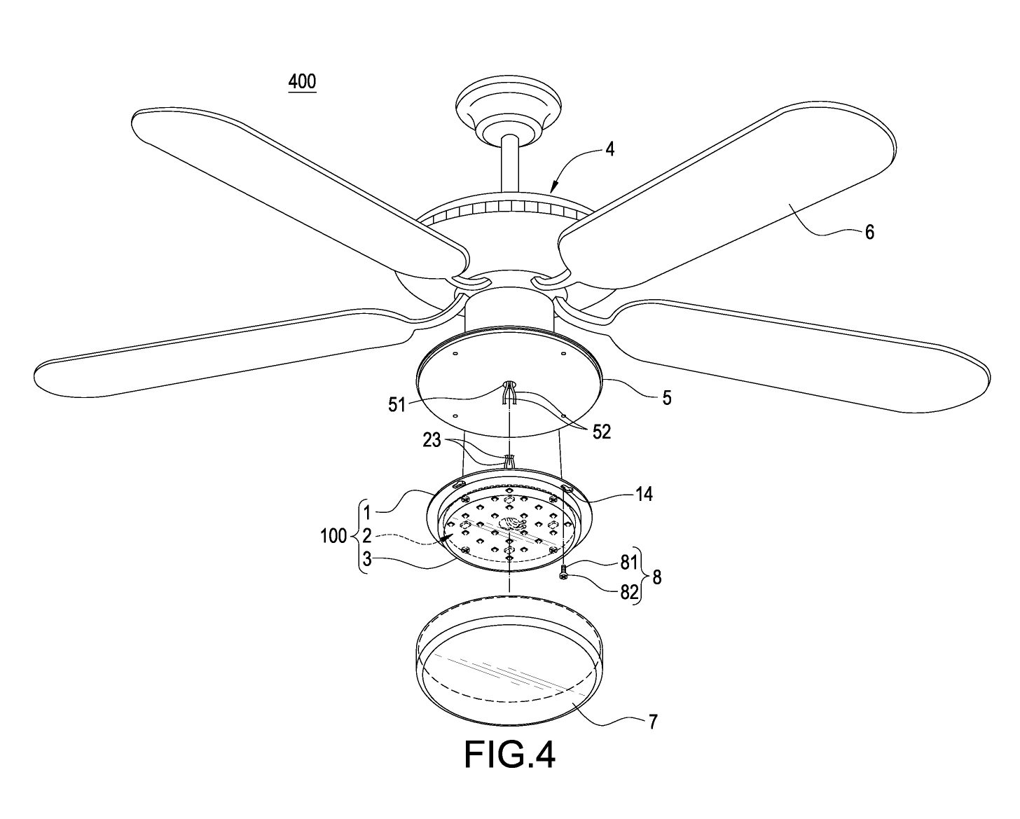

The disclosure provides a LED lamp for a ceiling fan and a ceiling fan having the LED lamp, as shown in FIG. 4. The ceiling fan having the LED lamp may be made by fixing the LED lamp 100 to the ceiling fan body 4, which enables the ceiling fan 400 to not only generate airflow but also perform lighting.

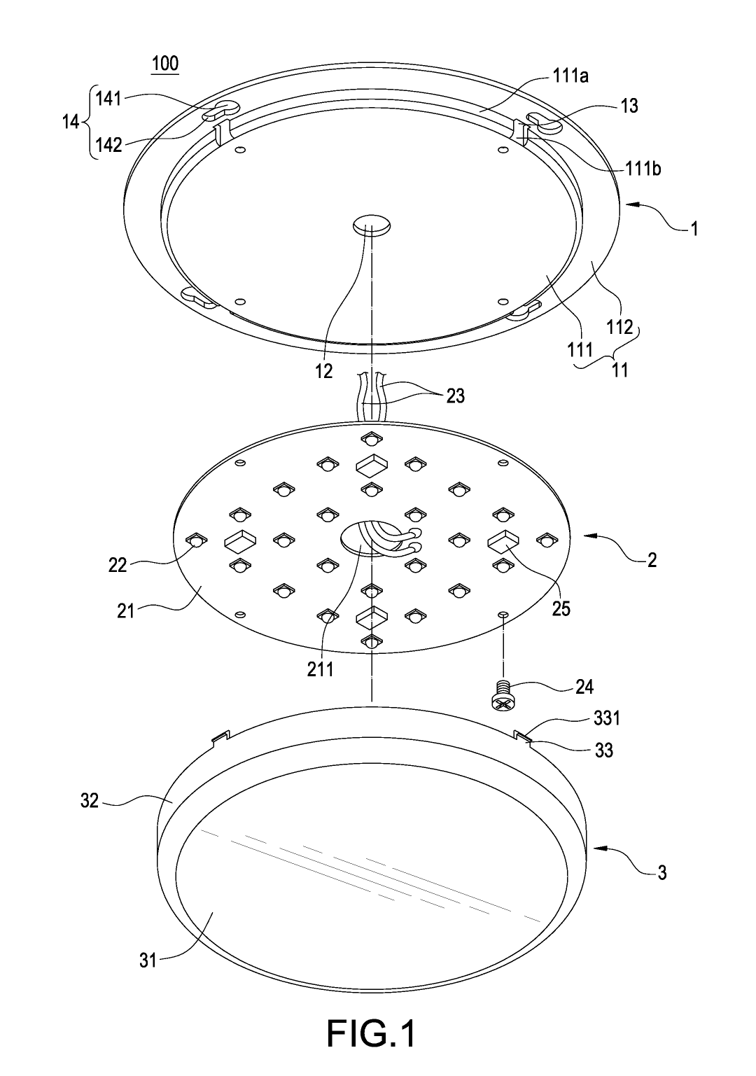

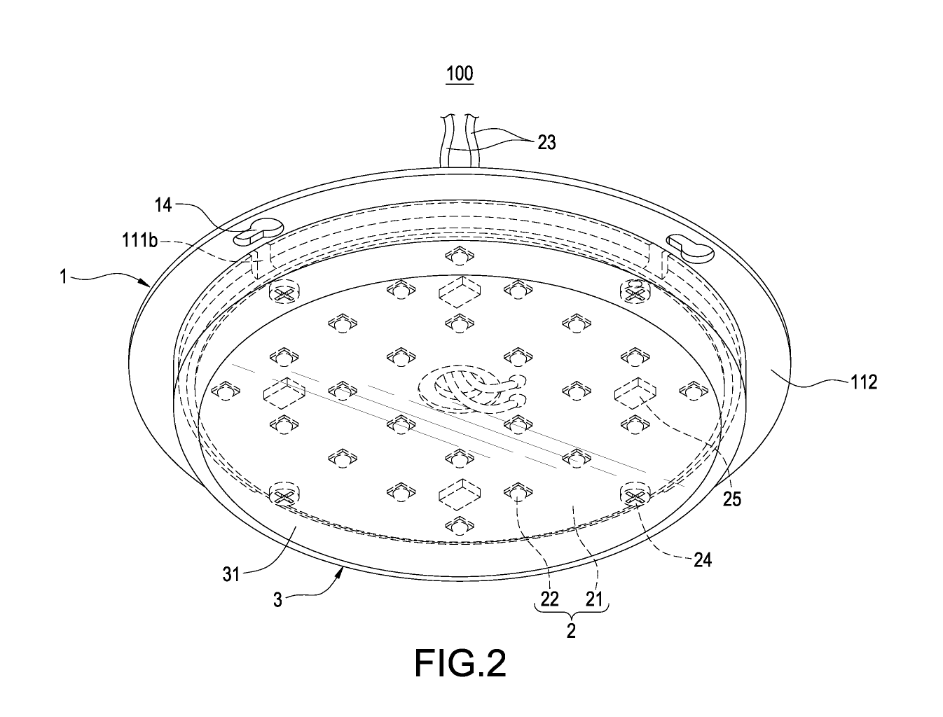

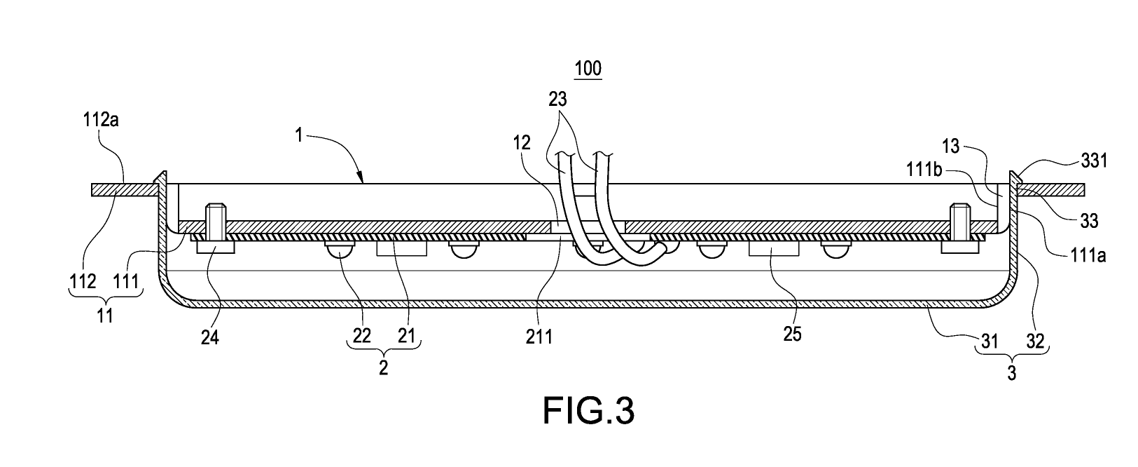

As seen in FIG. 1, FIG. 2 and FIG. 3, the LED lamp 100 comprises a plate body 1, a light module 2 and a translucent lampshade 3. The light module 2 is fixed to the plate body 1 while the translucent lampshade 3 covers the plate body 1. The light module 2, therefore, is between the plate body 1 and the translucent lampshade 3 and illuminating while facing the translucent lampshade 3.

The plate body 1 has an installation surface 11 and a back opposite to the installation surface 11. A plurality of fastening holes 13 is formed on the plate body 1 for the translucent lampshade 3 to be fixed to. In this embodiment, the installation surface 11 has a central protruding part 111 and a surrounding part 112 surrounding the central protruding part 111. The central protruding part 111 protrudes from the surrounding part 112 and therefore forms a peripheral edge 111a. The surrounding part 112 is connected to a height position of the peripheral edge 111a so there is a drop of height between the central protruding part 111 and the surrounding part 112. As shown in the figures, the surrounding part 112 is connected to the highest area of the peripheral edge 111a, but the disclosure is not limited thereto. Each fastening hole 13 corresponds to an edge between the surrounding part 112 and the peripheral edge 111a of the central protruding part 111. Furthermore, a plurality of grooves 111b is formed on the positions on the peripheral edge 111a corresponding to each fastening hole 13. Each groove 111b is connected to each fastening hole 13 so the grooves 111b are capable of guiding. Moreover, a through hole 12 is formed on the plate body 1 and between each fastening hole 13.

The light module 2 comprises a carrier board 21, a plurality of LED components 22 and a plurality of electronic components 25. The carrier board 21 is attached to and fixed to the central protruding part 111 of the installation surface 11. Each LED component 22 and each electronic component 25 are electrically disposed on the carrier board 21. In this embodiment, the carrier board 21 is a circuit board and a second power cord set 23, for being connected to the first power cord set 52 of the ceiling fan 400 (shown in FIG. 4) or for being connected to the power, is electrically connected to the carrier board 21. Additionally, a connecting hole 211 corresponding to the through hole 12 is formed on the carrier board 21. The second power cord set 23 passes through the connecting hole 211 as well as the through hole 12 and extends towards a direction away from the carrier board 21.

A plurality of fastening arms 33 corresponding to each fastening hole 13 is disposed on the translucent lampshade 3. Each fastening arm 33 forms a fastening body 331. The translucent lampshade 3 covers the installation surface 11 of the plate body 1 so that each fastening arm 33 plugs into each fastening hole 13 correspondingly. Thereby, the fastening body 331 of each fastening arm 33 corresponds to the positions of each fastening hole 13 and is fastened with the plate body 1. In this embodiment, the translucent lampshade 3 comprises a cover plate 31 and a surrounding plate 32 surrounding the cover plate 31. Each fastening arm 33 extends from a free edge of the surrounding plate 32. The fastening arm 33 is an elastic arm so it is flexible. The fastening body 331 is formed on a free end of the fastening arm 33 such that the fastening body 331 of the fastening arm 33 may be reversely fastened to the back 112a of the surrounding par 112 in relation to the position of the fastening hole 13.

Moreover, the shape of the translucent lampshade 3 corresponds to the shape of the central protruding part 111 for facilitating their connection. Thereby, the surrounding plate 32 of the translucent lampshade 3 may be attached to and surround the peripheral edge 111a of the central protruding part 111 (as seen in FIG. 3). This improves its sealability and aesthetics.

When assembling the LED lamp 100 of the disclosure, the carrier board 21 of the light module 2 may be fixed to the central protruding part 111 of the plate body 1 by the fixing member 24. Then, the second power cord set 23 passes through the connecting hole 211 of the through hole 12 and extends towards the direction away from the carrier board 21. Subsequently, the translucent lampshade 3 accordingly covers the central protruding part 111 of the plate body to make the surrounding plate 32 of the translucent lampshade 3 attach to and surround the peripheral edge 111a of the central protruding part 111. Each fastening arm 33 of the translucent lampshade 3, at this point, extends into the position of each fastening hole 13. Hence, at the end of the movement of the translucent lampshade 3 covering the central protruding part 111, the fastening body 3331 of each fastening arm 33 may reversely fasten to the back 112a of the surrounding part 112.

When assembling the lampshade 3, the fastening arm 33 is interfered with the edge of the surrounding part 112 corresponding to the position of the fastening hole 13 due to the fastening body 331 with a lateral protruding shape (as shown in FIG. 3). At this point, the fastening arm 33 is pushed and is elastically bent by the reaction force of the surrounding part 112 towards the fastening body 331. Each fastening arm 33 elastically bent is accommodated in each groove 111b to ensure that the fastening process of the fastening arm 33 is not interfered by or stuck in the fastening hole 13. While the translucent lampshade 3 is covering the central protruding part at the end of its movement, the fastening body 331 of the fastening arm 33 is reversely fastened to the back 112a of the surrounding part 112 accordingly. In other words, the fixing processes between the translucent lampshade 3 and the plate body 1 is simple and reliable. Users only need to move the translucent lampshade 3 towards the corresponding position of the plate body 1 to fasten the fastening arm 33 of the translucent lampshade 3 and its fastening body 331 with the plate body 1 in relation to the position of the fastening hole 13. This makes the assembly much easier and more convenient, which reduces the cost of assembly thereof.

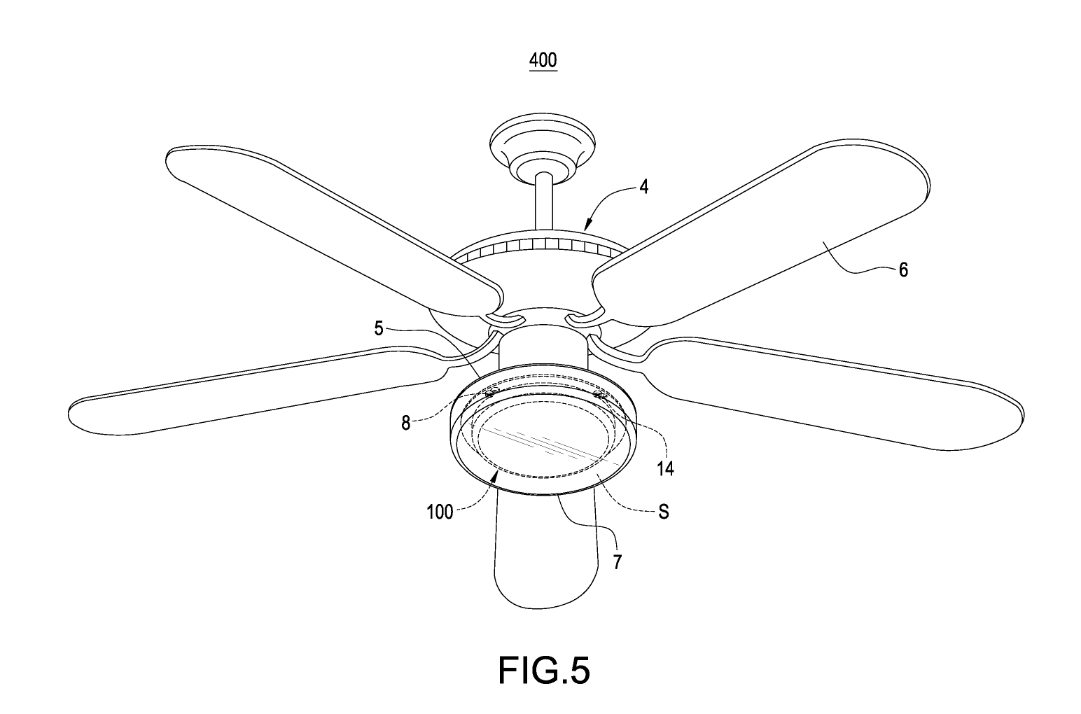

Referring to FIG. 4 and FIG. 5, the ceiling fan 400 of the disclosure comprises a ceiling fan body 4, a plurality of blades, an outer translucent mask 7 and the LED lamp 100 mentioned before. The LED lamp 100 is connected to a power via the ceiling fan body 4.

The ceiling fan body 4 is configured for being hung on a ceiling and has a fixing base 5 and the first power cord set 52 connected to the power. The blades 6 are connected to the ceiling fan body 4. In this embodiment, an opening 51 is formed on the fixing base 5 while the first power cord set 52 goes through the opening 51 and extends towards a direction away from the fixing base 5.

The outer translucent mask 7 covers and is fixed to the fixing base 5 so that the outer translucent mask 7 and the fixing base 5 form an accommodating space S therebetween (as seen in FIG. 5).

The LED lamp 100 of the disclosure is accommodated in the accommodating space S. For fixing the LED lamp 100 to the fixing base 5 of the ceiling fan 400, a plurality of fixing members 8 is disposed on the fixing base 5. In this embodiment, the fixing member 8 comprises a rod 81 and a head part 82 formed on one end of the rod 81.

A plurality of fixing holes 14 corresponding to each fixing member 8 is formed on the plate body 1 (referring to FIG. 1). In this embodiment, the fixing hole 14 is formed on the surrounding part 112 and comprises a large diameter part 141 with the aperture greater than the outer diameter of the head part 82 and a small diameter part 142 with the aperture less than the outer diameter of the head part 82. The large diameter part 141 and the small diameter part 142 are connected with each other, while the small diameter part 142 is only for the rod 81 to go through.

When fixing the plate body 1 of the LED lamp 100 to the fixing base 5 of the ceiling fan 400, the plate body 1 is attached to the fixing base to make each fixing member 8 plugs into the positions of each fixing hole accordingly. Specifically, the fixing member 8 with its head part 82 pass through the big diameter part 141 while its rod 81 is inside the fixing hole 14. Subsequently, rotate the LED lamp 100 relative to the fixing base so the rod 81 is moved from the large diameter part 141 of the fixing hole 14 to its small diameter part 142. The head part 82 of the fixing member 8, at the same time, is reversely fastened to the back 112a of the surrounding part 112 (not shown in the figures but can be known by referring to FIG. 3). The LED lamp 100, therefore, is fixed to the fixing base 5 of the ceiling fan 400. Lastly, the outer translucent mask 7 covers and is fixed to the fixing base 5. The connecting method between the outer translucent mask 7 and the fixing base 5 is not limited to any particular method. For instance, they can be connected by being tightened together or by being screwed to each other (e.g. the outer edge of the fixing base 5 is arranged with an external thread while the inner edge of the outer translucent mask 7 is arranged with an internal thread).

When the LED lamp 100 is assembled to the fixing base 5 of the ceiling fan 400, the first power cord set 52 of the ceiling fan body 4 extends towards the LED lamp 100 while the second power cord set 23 of the light module 2 extends towards the fixing base 5. That is, the first power cord set 52 and the second power cord set 23 are near each other for facilitating their connection.

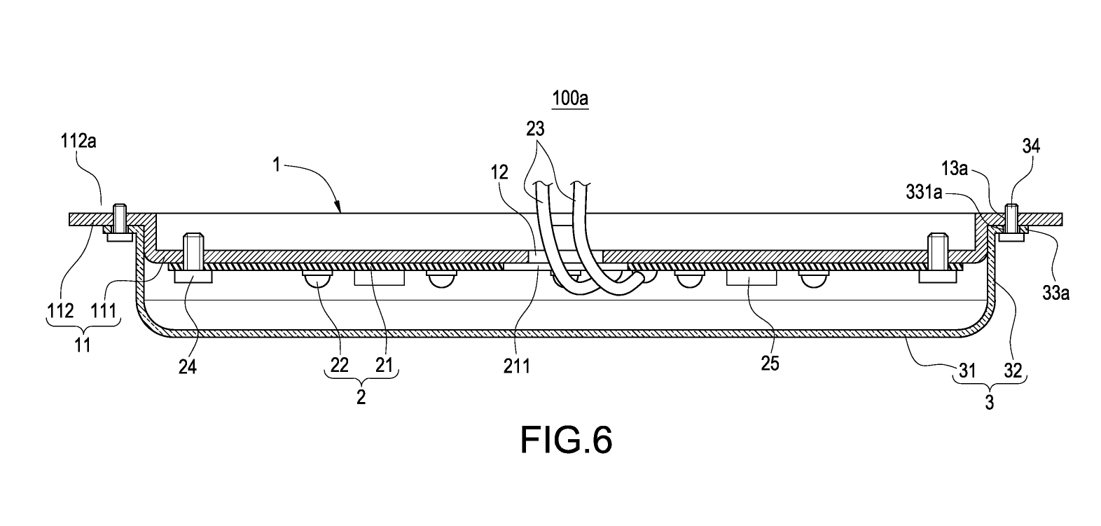

FIG. 6 is a sectional view of a LED lamp according to another embodiment of the disclosure. The LED lamp 100a of this embodiment is similar to that shown in FIG. 1 to FIG. 3 but the fixing method regarding the translucent lampshade 3 and the plate body 1 is different. A plurality of screwing holes 13a corresponding to the surrounding part 112 is formed on the plate body 1. A plurality of protruding blocks 33a is disposed on the translucent lamp shade 3. A plurality of penetrating holes 331a corresponding to the position of each screwing hole 13a is formed on each protruding block 33a so a plurality of screwing members 34 goes through each penetrating hole 331a and is screwed to each screwing hole 13a. Thereby, the translucent lampshade 3 is fixed to the plate body 1.

To sum up, when assembling the LED lamp 100 or 100a, the translucent lampshade 3 covers the central protruding part 111 correspondingly and is fixed to the plate body 1. Consequently, compared to Prior Art, it is easier and more convenient in terms of assembly processes and this reduces the cost of assembly. With regard to the embodiment shown in FIG. 1 to FIG. 3, using the translucent lampshade 3 to cover the central protruding part 111 accordingly may make the fastening arm 33 of the translucent lampshade 3 reversely fasten with the back of the plate body 1 directly at the final point of the movement of the translucent lampshade 3 covering the central protruding part 111. This makes the assembly processes easier and more convenient and reduces the cost of assembly. In the embodiment of FIG. 6, the translucent lampshade 3 corresponds to and covers the central protruding part 111 while the screwing member 34 is goes through the penetrating hole 331a and is screwed to the screwing hole 13a. Thereby, the translucent lampshade 3 is fixed to the plate body 1. Compared to Prior Art, this is much easier and more convenient, which reduces the cost of assembly.

Additionally, the shape of the translucent lampshade 3 corresponds to the shape of the central protruding part 111. This improves the sealability and aesthetics of the translucent lampshade 3 and the plate body 1. Via the grooves 111b formed on the peripheral edge 111a, the fastening process of the fastening arm 33 is not interfered by or stuck in the fastening hole 13. Furthermore, the fixing member 8 disposed on the fixing base 5 and the fixing hole 14 of the plate body 1 enable the LED lamp 100 to be directly fixed to the fixing base 5 in an easy way.

What is claimed is:

1. A LED lamp (100) for a ceiling fan, comprising:
a plate body (1) having a central protruding part (111) and a surrounding part (112) surrounding the central protruding part (11), wherein the central protruding part (11) protrudes from the surrounding part (112);
a light module (2) comprising a carrier board (21) fixed to the central protruding part (111) and a plurality of LED components (22) as well as a plurality of electronic components (25) which are electrically disposed on the carrier board (21); and
a translucent lampshade (3) corresponding to and covering the central protruding part (111) and fixed to the plate body (1), wherein the light module is between the translucent lampshade (3) and the plate body (1).

2. The LED lamp for the ceiling fan according to claim 1, wherein a plurality of fastening holes (13) is formed on an edge between the central protruding part (111) and the surrounding part (112), a plurality of fastening arms (33) corresponding to positions of the fastening holes (13) for being plugged into is disposed on the translucent lampshade (3), each of the fastening arms (33) forms a fastening body (331), and the fastening body (331) of each fastening arm (33) corresponds to a position of each fastening hole (13) and is therefore fastened to a back (112a) of the surrounding part (112) to be fixed.

3. The LED lamp for the ceiling fan according to claim 2, wherein the central protruding part (111) has a peripheral edge (111a), the surrounding part (112) is connected to a height position of the peripheral edge (111a), a plurality of grooves (111b) corresponding to the position of each fastening hole is formed on the peripheral edge (111a) and each groove (111b) and each fastening hole (13) are connected.

4. The LED lamp for the ceiling fan according to claim 2, wherein the translucent lampshade (3) comprises a cover plate (31) and a surrounding plate (32) surrounding the cover plate (31), and each of the fastening arms (33) extends from a free edge of the cover plate (32).

5. The LED lamp for the ceiling fan according to claim 2, wherein each of the fastening arms (33) is an elastic arm and a free end of the fastening arm (33) forms the fastening body (331).

6. The LED lamp for the ceiling fan according to claim 1, wherein a shape of the translucent lampshade (3) corresponds to a shape of the central protruding part (111) of the plate body (1), thereby facilitating the connection processes of them.

7. The LED lamp for the ceiling fan according to claim 1, wherein a through hole (12) is formed on the plate body (1), a connecting hole (211) corresponding to the through hole (12) is formed on the carrier board (21) of the light module (2), the carrier board (21) is electrically connected to a second power cord set (23) going through the connecting hole (211) and the through hole (12).

8. The LED lamp for the ceiling fan according to claim 1, wherein a plurality of screwing holes (13a) corresponding to the surrounding part (112) is formed on the plate body (1), a plurality of protruding blocks (33a) is disposed on the translucent lamp shade (3), a plurality of penetrating holes (331a) corresponding to a position of each screwing hole 13a is formed on each protruding block (33a), and a plurality of screwing members (34) goes through each penetrating hole (331a) and is screwed to each screwing hole (13a).

9. A ceiling fan having a LED lamp, comprising
a ceiling fan body (4) having a fixing base (5);
a plurality of blades (6) connected to the ceiling fan body (4);
an outer translucent mask (7) covering and fixed to the fixing base (5), wherein the outer translucent mask (7) and the fixing base (5) form an accommodating space (S) therebetween; and
the LED lamp (100) accommodated in the accommodating space (S) and comprising a plate body (1), a light module (2) and a translucent lampshade (3):
the plate body (1) being fixed to the fixing base (5) and having a central protruding part (111) and a surrounding part (112) surrounding the central protruding part (111), wherein the central protruding part (111) protrudes from the surrounding part (112);
the light module (2) comprising a carrier board (21) fixed to the central protruding part (111) and a plurality of LED components (22) as well as a plurality of electronic components (25) which are electrically disposed on the carrier board (21); and
the translucent lampshade (3) corresponding and covering to the central protruding part (111) and fixed to the plate body (1), wherein the light module (2) is between the translucent lampshade (3) and the plate body (1).

10. The ceiling fan according to claim 9, wherein the ceiling fan body has a first power cord set (52), the carrier board (21) is electrically connected to a second power cord set (23) while the first power cord set (52) and the second power cord set (23) are connected and are electrically conducted with each other.

11. The ceiling fan according to claim 10, wherein an opening (51) is formed on the fixing base (5), a through hole (12) is formed on the plate body (1) of the LED lamp (100), a connecting hole (211) corresponding to the through hole (12) is formed on the carrier board (21) of the light module (2), the first power cord set (52) goes through the opening (51) and extends towards the LED lamp (100), the second power cord set (23) goes through the connecting hole (211) and the through hole (12) and extends towards the fixing base (5) for being connected to the first power cord set (52).

12. The ceiling fan according to claim 9, wherein a plurality of fixing members (8) is disposed on the fixing base (5), each fixing member (8) comprises a rod (81) and a head part (82) formed on one end of the rod (81), a plurality of fixing holes (14) corresponding to each fixing member (8) is formed on the plate body (1) of the LED lamp (100), each fixing hole (14) comprises a large diameter part (141) with an aperture greater than an outer diameter of the head part (82) and a small diameter part (142) with an aperture less than an outer diameter of the head part (82), the large diameter part (141) and the small diameter part (142) are connected with each other, each fixing member (8) with the head part (82) is configured for plugging into the large diameter part (141) while the small diameter part (142) is only for the rod (81) of each fixing member (8) to go through, and the head part (82) of each fixing member (8) corresponds to a position of each small diameter part (142) and is reversely fastened to a back (112a) of the plate body (1).

13. The ceiling fan according to claim 9, wherein a plurality of fastening holes (13) is formed on an edge between the central protruding part (111) and the surrounding part (112), a plurality of fastening arms (33) corresponding to positions of the fastening holes (13) for being plugged into is disposed on the translucent lampshade (3), each of the fastening arms (33) forms a fastening body (331), and the fastening body (331) of each fastening arm (33) corresponds to a position of each fastening hole (13) and is therefore fastened to a back (112a) of the surrounding part (112) to be fixed.

14. The ceiling fan according to claim 13, wherein the central protruding part (111) has a peripheral edge (111a), the surrounding part (112) is connected to a height position of the peripheral edge (111a), a plurality of grooves (111b) corresponding to the position of each fastening hole (13) is formed on the peripheral edge (111a) and each groove (111b) and each fastening hole (13) are connected.

15. The ceiling fan according to claim 13, wherein the translucent lampshade (3) comprises a cover plate (31) and a surrounding plate (32) surrounding the cover plate (31), each of the fastening arms (33) extends from a free edge of the cover plate (32).

16. The ceiling fan according to claim 13, wherein each of the fastening arms (33) is an elastic arm and a free end of the fastening arm (33) forms the fastening body (331).

17. The ceiling fan according to claim 9, wherein a shape of the translucent lampshade (3) corresponds to a shape of the central protruding part (111) of the plate body (1), thereby facilitating the connection processes of them.

18. The ceiling fan according to claim 9, wherein a through hole (12) is formed on the plate body (1), a connecting hole (211) corresponding to the through hole (12) is formed on the carrier board (21) of the light module (2), the carrier board (21) is electrically connected to a second power cord set (23) going through the connecting hole (211) and the through hole (12).

19. The ceiling fan according to claim 9, wherein a plurality of screwing holes (13a) corresponding to the surrounding part (112) is formed on the plate body (1), a plurality of protruding blocks (33a) is disposed on the translucent lamp shade (3), a plurality of penetrating holes (331a) corresponding to a position of each screwing hole (13a) is formed on each protruding block (33a), and a plurality of screwing members (34) goes through each penetrating hole (331a) and is screwed to each screwing hole (13a).
